(19) United States
(12) Patent Application Publication
(10) Pub. No.: US 2005/0203684 A1
(43) Pub. Date: Sep. 15, 2005

(54) Vehicle control system and method of controlling such

(76) Inventor: Goran Borgesson, Skarham (SE)

Correspondence Address: YOUNG & THOMPSON, 745 SOUTH 23RD STREET, 2ND FLOOR, ARLINGTON, VA, 22202, US

(21) Appl. No.: 10/501,081

(22) PCT Filed: Dec. 19, 2002
(86) PCT No.: PCT/SE02/02413

§ 371 Date: May 25, 2005

(30) Foreign Application Priority Data
Jan. 11, 2002 (SE) 0200093-3

(51) Int. Cl. G06F 17/00

(52) U.S. Cl. 701/36; 701/1

(57) ABSTRACT

Vehicle control system (10), capable of controlling a number of controllable motor vehicle subsystems (30-80) according to at least two preset vehicle operating modes. The control system comprises a central control unit (20) for controlling the motor vehicle subsystems (30-80), and a driver interface (90) with an input arrangement (92) and an output arrangement (94) for selecting operating mode. Furthermore, the control system comprises at least one sensor (100-130) for registering current operating conditions, and the central control unit (20) is arranged to limit access to at least one of the preset operating modes in response to an output value from at least one sensor (100-130).

The present invention relates to a vehicle control system and method of controlling such, and in particular to a new vehicle control system capable of controlling a number of controllable motor vehicle subsystems (30-80) according to a number of preset vehicle operating modes.

### BACKGROUND OF THE INVENTION

In recent years, improvements in electrical and electronic components have increased their reliability and acceptance in the hostile motor vehicle environment. The electronic component is often a microprocessor, which introduces the versatility of program control into operating subsystems of a motor vehicle.

One operating subsystem, which has been substantially taken over by electronic or computer control is the engine operating or control subsystem. Computer control of internal combustion engines has been effectively mandated by the precision required to meet fuel efficiency and environmental protection requirements and the continuing demand for superior vehicle performance. Today, many vehicles can be bought in several models with characteristics that differ from each other, even though they are based on substantially the same hardware. The only difference lies in software related settings for engine characteristics and the like, and it is not unusual that the same engine hardware is used for models having an engine power that varies within a range of up to 30 kW or more. However, high power outtake is from an engine often results in increased wear of the engine components, such that the potential use of certain high performance vehicles sometimes has to be limited.

Other examples of motor vehicle operating subsystems, which have been enhanced by the improved control possible by using electronic and electrical control systems include anti-lock brakes, active and/or adjustable suspension subsystems, power assisted steering, traction control subsystems, entertainment subsystems, and comfort/convenience subsystems.

While operation of the noted, as well as other vehicle operating subsystems has been improved by the conversion to electrical and electronic control, each known operating subsystem has been developed as a substantially autonomous, stand-alone entity. Operating characteristics of such autonomous subsystems often can be adjusted during production of a motor vehicle and, to a much more limited extent, after production by a vehicle dealer or customer. Unfortunately, by-in-large the operating characteristics of such autonomous subsystems are fixed at production and can only be changed by replacement or retrofitting of a new autonomous subsystem.

Examples of vehicle operating subsystems which can be adjusted after production include: some suspension subsystems which can be adjusted, for example among hard, normal and soft settings by the vehicle operator; engine control subsystems which can be adjusted between economy and power settings; traction control subsystems which can be adjusted between four-wheel drive and two-wheel drive; and, comfort/convenience subsystems which can be set to preposition a seat, steering wheel and the like for one or more operators.

U.S. Pat. No. 5,091,856, Hitachi Ltd, discloses the use of a system manager for controlling all such subsystems in a vehicle according to personalized settings. The system rely upon that each driver of the vehicle has an identification card, which is read and identified by the system manager. To personalize the vehicle each driver has to make his/her own choice for each subsystem. The system also gives the driver the possibility to select the appearance of the dashboard, by use of a display type dashboard.

U.S. Pat. No. 5,513,107, Ford Motor Company, discloses the use of a vehicle controller for controlling the subsystems in a vehicle according to preset operating modes. Parameters for operation of a number of vehicle operating subsystems are stored in the vehicle controller and selected to control and configure the operating subsystems. Control and configuration can be based on individually recognized operators of the vehicle, or an operating mode can be selected for the vehicle. For example, sport, cruise, luxury, off-road or other performance modes can be set up and selected. If a vehicle is to be operated by an authorized person who is not a recognized operator or is not authorized to select a mode of operation, default operating characteristic parameters are stored and selected. If the authorized person is to be restricted in the possible operation of the vehicle, a further set of limited operating characteristic parameters are stored and selected, preferably by entry of control signals corresponding to a security code. For example, if a valet is parking the vehicle, the limited operating parameters are selected. For security purposes, the limited operating parameters can be invoked after a defined period of time.

U.S. Pat. No. 5,525,977, Prince Corp, discloses a personalization system for vehicles that uses a CD player and a keyless entry transmitter. The CD player outputs audible prompting signals including accessory operation choices. The driver selects accessory operation by pressing the “LOCK” or “UNLOCK” switch on the keyless entry key fob following an associated audio prompting signal. A controller coupled to the CD player receives a selection signal from the keyless entry key fob and associates the receipt of the selection signal with an index corresponding to the audio prompting signal last output by the CD player. The controller controls accessory operation according to the accessory options selected responsive to the audible prompting signal.

U.S. Pat. No. 6,205,374, Mazda Motor Corporation, discloses a personalization system for vehicles, wherein the settings of the vehicle subsystems are set by, the sales agent, to meet preference of driver, a driver's taste, driving condition, driving circumstances and the like

U.S. Pat. No. 6,253,122, Sun Microsystems Inc, discloses a dashboard for a vehicle, comprising a monitor, which displays graphical images depicting dashboard instruments. The images displayed to the driver are determined by the virtual dashboard application, and not by the monitor itself. The displayed images are user-selectable so that they can be varied to suit the preferences of different drivers. The driver may alternately select different groups of images to view on the monitor using touch screens or speech commands.

EP1034470 B1, BMW, discloses user interface for a feature/accessory control system of a vehicle, which system comprises a device for controlling a display screen with an actuating element which can be rotated about a longitudinal axis and moved in the direction of the longitudinal axis, enabling a point of a menu structure consisting of menu, partial menus, functions and/or function values to be selected, and which can be represented as an optically highlighted field in the display screen. The actuating element has an initial position and can describe with relation thereto an additional movement with two additional degrees of freedom. The additional movement of the actuating element enables a field arranged in a marginal region (2) of the display screen and associated with a point of the menu structure to be selected. The rotary/longitudinal movement of the actuating element enables a subordinate field of the menu structure associated with the field arranged in the marginal region of the display screen to be selected in the central region (3) of the display screen enclosed by the marginal region.

Throughout this application the term vehicle is intended to include all possible vehicles on which the invention may be applied, and especially all types of automobiles.

### SUMMARY OF THE INVENTION

The object of the invention is to provide a new vehicle control system and method of controlling such, which system and method overcomes one or more drawbacks of the prior art. This is achieved by the system as defined in claim 1, and by the method as defined in claim 21.

One advantage with such a vehicle control system with limited operating modes is that the vehicle characteristics for such modes can be set to more extreme levels without the risk of damage to the vehicle, due to non-suitable use of the vehicle.

Another advantage is that non-safe use of the vehicle due to over-load or high speed in non-suitable modes is prevented, without limiting use of the vehicle for carrying heavy loads or for high speed driving under suitable conditions in appropriate modes. One and the same vehicle can therefore be mode-transformed such that optimum characteristics are set according to the current driving circumstances, whereby maximum versatility and safety is achieved.

Another advantage is that the vehicle control system automatically adapts the performance of the vehicle to a suitable operating mode.

Embodiments of the invention are defined in the dependent claims.

### BRIEF DESCRIPTION OF THE DRAWINGS

The invention will be described in detail below with reference to the drawings, in which

FIG. 1 schematically shows one embodiment of a vehicle control system according to the present invention in a vehicle.

FIG. 2a schematically shows the settings of a vehicle in sport mode.

FIG. 2b schematically shows the settings of a vehicle in off-road mode.

FIG. 2c schematically shows the settings of a vehicle in heavy load mode.

FIG. 3a is a schematic view of a dashboard-image according to one embodiment of the invention

FIG. 3b shows a schematic example of a leisure mode adapted dashboard-image.

FIG. 3c shows a schematic example of a sport mode adapted dashboard-image.

FIG. 3d shows a schematic example of an off-road mode adapted dashboard-image.

FIG. 3e shows a schematic example of a parking mode adapted dashboard-image.

FIG. 4 schematically shows the menu options in top menu state of the sport mode.

FIG. 5 schematically shows an input arrangement according to one embodiment of the invention.

FIG. 6 shows an example of a menu selection process according to one embodiment of the invention.

### DETAILED DESCRIPTION OF PREFERRED EMBODIMENTS

One basic feature of the present invention is to further develop the ideas from U.S. Pat. No. 5,513,107, relating to configuration of a vehicle according to a number of preset operating modes. There are two main reasons why selectable configuration of a vehicle by preset operating modes is preferred. Firstly, too many individual configuration possibilities are frustrating and too complicated for the majority of the drivers of such vehicles. Secondly, preset operating modes leaves the control of the vehicle performance and characteristics to the manufacturer, whereby a certain security level, road performance, manoeuvrability and the like can be guaranteed. Throughout this application, the term operating mode is defined in that any two operating modes are distinguished from each other, in that the mode specific settings differ for at least two separate vehicle subsystems.

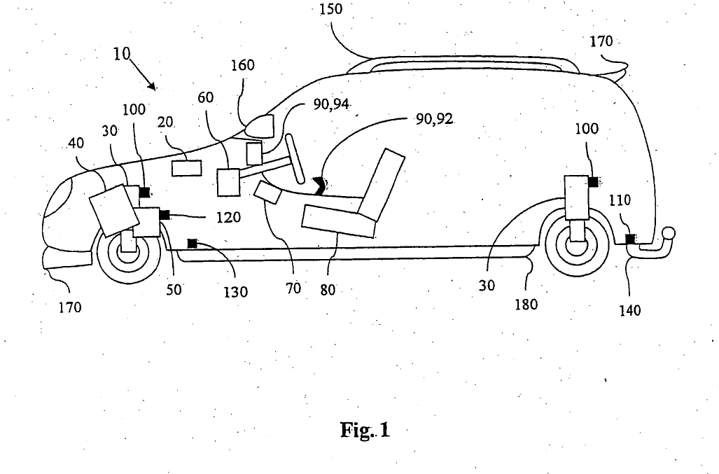

FIG. 1 schematically shows one embodiment of a vehicle control system 10 according to the present invention, comprising a central control unit 20, a number of controllable subsystems 30-80 represented by a chassis control system 30, an engine control system 40, a power train control system 50, a steering control system 60, a climate control system 70, and a seating control system 80. Naturally, a vehicle control system 10 according to the invention does not need to comprise all these subsystems, and other subsystems may be included, as will be clear below. Each of said subsystems 30-80 may, as been discussed above, be set into a number of operating modes, which in this specific invention are adapted for optimum performance in the different preset operating modes of the vehicle.

The central control unit 20 basically is a computer comprising a processor for execution of the different operating mode selections and memory means for storing operating mode related settings. In a preferred embodiment the central control unit 20 also is a central component in a vehicle infotainment system, by which the driver/passengers of the vehicle can access entertainment in the form of music, video, games and the like, as well as information in the form of e-mail, internet, mobile phone and the like. In such infotainment systems, one or more displays and input devices are connected to the central control unit 20. Furthermore, the driver interface of the vehicle control system 10 is preferably integrated as a part of the vehicle infotainment system, which will be discussed in detail below. All subsystems 30-80 are connected to the central control unit 20, such that the central control unit 20 can set the required parameters of the individual subsystems 30-80 to the values that corresponds to the selected operating mode. In an alternative embodiment, one or more subsystem control systems are integrated with the central control unit 20, whereby the central control unit directly controls the properties of the subsystem.

The chassis control system 30 is arranged to control adjustable chassis parameters of the vehicle in accordance with the selected operating mode or personal selections if available. Controllable chassis parameters comprise suspension parameters like damping and stiffness, vehicle ground clearance, horizontal leveling, wheel track and the like. By controlling these parameters the chassis may be adopted for optimum performance in different driving situations, or operating modes, as will be discussed below.

The engine control system 40 is arranged to control the performance of the engine in the vehicle with respect to parameters such as power, torque, fuel consumption, emission level, duration and the like.

The power train control system 50 is arranged to control adjustable power train parameters of the vehicle in accordance with the selected operating mode or personal selections if available. Controllable power train parameters comprise gearbox operation parameters, two/four-wheel drive selections, anti-spin settings and the like.

The steering control system 60 is arranged to control adjustable steering parameters of the vehicle in accordance with the selected operating mode or personal selections if available. Controllable steering parameters comprise degree of power assistance, steering wheel gear ratio and the like.

The climate control system 70 is arranged to control the climate in the vehicle.

The seating control system 80 is arranged to control adjustable seating parameters of the vehicle in accordance with the selected operating mode or personal selections if available. Controllable seating parameters comprise personalized comfort parameters for adjustment of individual seats, parameters for automatic adjustment of the cargo space by moving or folding seats, and parameters defining mode related transformation of seats into comfort mode, bucket mode or the like.

The vehicle control system 10 further comprises a driver interface 90, which preferably comprises an input arrangement 92 and an output arrangement 94. The input arrangement 92 is e.g. formed by one or more push buttons, a joystick type controller, speech recognition, or any combination thereof The output arrangement 94 is e.g. formed of a graphical display, indicator lamps or diodes, sound/voice messages, or any combination thereof. A preferred embodiment of the driver interface is described in detail below.

Furthermore the vehicle control system 10 comprises a number of sensors 100-130 for registering current operating conditions. In this first embodiment the sensors 100-130 are represented by a number of load sensors 100, a towing sensor 110, a speed sensor 120, and a tilting sensor 130. Hence, the current operating conditions registered comprise load, towing, speed and tilting of the vehicle. Preferably, there is one load sensor 100 associated with the wheel suspension of each wheel, for accurate monitoring of the load in the vehicle. The load sensors 100 register the load both when the vehicle is standing still and when it is in motion. The towing sensor 110 is a sensor that is arranged to recognize if the vehicle is used for towing a trailer or the like, and it may give a response signal to the central control unit 20, e.g. in response to the force applied to a towing hook, if a detachable towing hook is arranged in position, if a trailer is electrically connected to the vehicle or the like. The speed sensor 120 gives a signal corresponding to the actual speed of the vehicle. The tilting sensor 130 registers tilting of the vehicle.

Additionally, the vehicle control system 10 may comprise a number of controllable accessory systems 140-180, herein represented by an electrically foldable towing hook 140, an electrically foldable roof rack 150, electrically extendable external rear view mirrors 160, electrically adjustable spoilers and body skirts 170, and electrically foldable chassis protection rails or bumpers 180. The electrically foldable towing hook 140 has two modes of operation: a towing mode, and a hidden mode. In the towing mode the hook may be used for towing a trailer or the like, whereas it is prevented from use in the hidden mode. In a similar fashion the electrically foldable roof rack 150 has a loading mode and a hidden mode. The electrically foldable roof rack 150 can further be equipped with automatic load fastening means, which preferably can be adjusted according to a number of memorized positions. Furthermore, the electrically foldable roof rack 150 may be used as carrier for supplementary driving lamps. The electrically extendable external rear view mirrors 160 can be extended to achieve acceptable rear view when towing of a wide trailer, such as a caravan or the like. The electrically adjustable spoilers and body skirts 170 are used to change the aerodynamic characteristics of the vehicle depending on operating mode and speed. The electrically foldable chassis protection rails or bumpers 180 are situated underneath the vehicle and have two modes of operation: a hidden mode and a protection mode. In the protection mode the chassis protection rails protects the chassis from damage during off-road conditions.

As mentioned above the vehicle control system 10 is intended for use in at least two preset operating modes. Examples of such modes are, Leisure, Economy, Sport, Off-road, Heavy load, Zero emission, and Parking. The basic features for each such mode are:

Leisure

May also be referred to as normal driving mode, and is characterized by a high comfort level in all senses, such as comfortable suspension and smooth automatic transmission.

Economy

All adjustable parameters are optimized to achieve the lowest possible fuel consumption. The vehicle control system 10 may instruct (guide) the driver how to drive to achieve reduced fuel consumption.

Sport

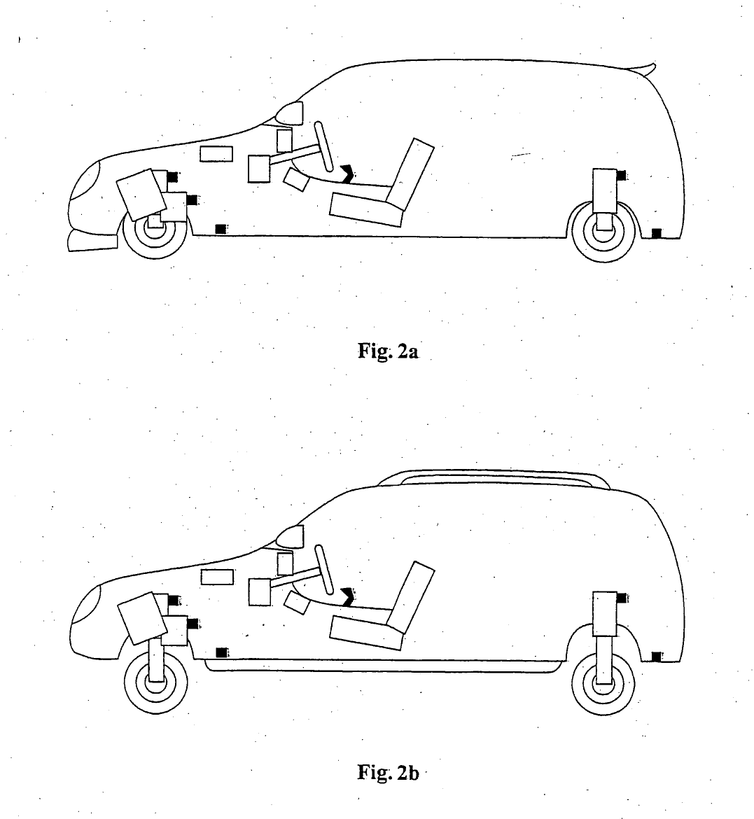

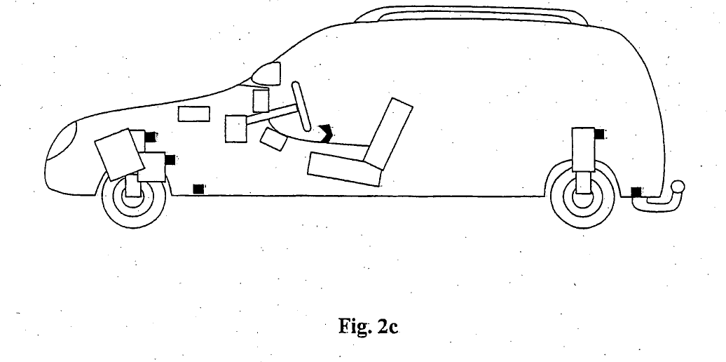

The characteristics of the chassis settings are changed to improve the road handling characteristics, e.g. setting the suspension in a stiff state, activating active anti-roll stabilization, and the like. The transmission and engine-settings are changed to achieve increased power and rapid acceleration. The aerodynamic characteristics are improved by changing the settings of the electrically adjustable spoilers and body skirts 170, and/or by tilting the body of the vehicle. (FIG. 2a)

Off-road

The chassis is raised to increase the ground clearance of the vehicle, and four-wheel drive is activated. The transmission and engine-settings are changed to achieve increased torque and low speed capabilities. The electrically controllable chassis protection rails or bumpers 170 are set in the protection mode. (FIG. 2b)

Heavy Load

The suspension is adjusted according to the load, the transmission and engine-settings are changed to achieve increased torque, and four-wheel drive is activated. (FIG. 2c)

Zero-emission

Measures are taken such that the vehicle does not emit any exhaust fumes

Parking

Depending on the type of vehicle the chassis is raised or lowered to facilitate getting in and getting out of the vehicle.

It should be understood that the features of the different modes might be altered and adapted to the vehicle in which the vehicle control system 10 is arranged. Furthermore, all proposed modes are not necessarily available in vehicles equipped with the vehicle control system 10 according to the invention, i.e. the number of modes that are available in a vehicle is adapted to the vehicle type. In addition to the functional mode features proposed above, additionally features may be altered between the mode transformations, such as the appearance, and the sound impression of the vehicle.

In a preferred embodiment of the present invention, the central control unit 20 is arranged to limit possible mode selections in accordance with a number of preset operation rules to assure maximum performance and safe operation of the vehicle in the different modes. Examples of such rules are:
a. Sport mode is not selectable when the load registered by the load sensors 100 exceeds a preset load limit.
b. Sport mode is not selectable when the towing sensor 110 indicates that there is a trailer or the like hooked onto the towing hook. When the vehicle is equipped with an electrically foldable towing hook 130, sport mode is not selectable when the hook is in towing position. Similarly the electrically foldable towing hook 130 cannot be set in towing position, when sport mode is selected.
c. The electrically foldable roof rack 150 is not selectable in sport mode.
d. Heavy load mode is automatically selected when the load registered by the load sensors 100 exceeds a preset load limit.
e. Heavy load mode is automatically selected when the towing sensor 110 indicates that there is a trailer or the like hooked onto the towing hook. When the vehicle is equipped with an electrically foldable towing hook 140, heavy load mode is automatically selected when the hook is set in towing position.
f. In off-road mode, the vehicle is limited to use below a predefined speed limit, and if the speed registered by the speed sensor 120 reaches the speed limit, then the vehicle control system 10 prevents further acceleration.
g. Off-road mode is locked when the tilting angle registered by the tilting sensor 130 exceeds a predetermined value that indicates that the vehicle is in an advanced off-road situation.
h. Sport mode is not directly selectable from off-road mode, i.e. the vehicle has to be set in another non off-road mode before sport mode is selected.

One major advantage with limited operating modes is that the vehicle characteristics for such modes can be set to more extreme levels without the risk of damage to the vehicle, due to non-suitable use of the vehicle. Another advantage is that non-safe use of the vehicle due to over-load or high speed in non-suitable modes is prevented, without limiting use of the vehicle for carrying heavy loads or for high speed driving under suitable conditions in appropriate modes.

Rules a and b, both limits non-suitable use of the vehicle in the sport mode, with regard to the total load of the vehicle. By setting the over all load limit for the sport mode to a level that e.g. corresponds to a load of two persons for a conventional middle class automobile, the subsystems settings can be set to a level that corresponds to the performance of a two seated sport car. If such extreme settings were available under any conditions, there is an obvious risk that the vehicle could be damaged, especially the engine and the power train. This may be compared with conventional middle class automobiles available as extreme sport versions, which must be kept at a “safe level” to prevent damage on the vehicle, whereby top performance is excluded at the same time as use for carrying heavy loads and/or towing trailers or the like is permanently prevented by model regulations or the like.

Rule c is mainly intended for limiting the possibility of loading objects on the roof of the vehicle. This is highly undesirable, as the high forces that they may be subjected to in the sport mode may cause the objects to break loose. A roof rack further has a negative effect on the aerodynamics of the vehicle, especially if it is used for carrying a load.

Rules d and e promotes optimum performance when the vehicle is used for carrying heavy loads and/or is used for towing. By automatically selecting the high load mode under conditions of heavy load, excessive wear and risk for damage of the engine and power train is prevented, at the same time as the best possible driver comfort is achieved in terms of high low speed power, road stability and the like. As indicated in rule e, the electrically foldable towing hook 130 preferably is exclusively associated with this mode, whereby use of the vehicle for towing in other modes is effectively prevented.

As the off-road mode is intended for use under low speed conditions where increased accessibility is needed, and therefore has reduced high-speed characteristics, rule f prevents use of off-road mode at speeds exceeding a predetermined speed limit. Rule g prevents accidental switching from off-road mode to a non-off-road mode in situations where off-road mode is required to maintain accessibility. If sport mode could be selected directly from off-road mode there is a risk that the sport mode is selected when the road conditions are too rough resulting in damage on the chassis and/or spoilers. Therefore, rule h prevents such direct switching and an intermediate mode, with respect to ground clearance, has to be selected before sport mode is accessible. If the road conditions then are too rough, the intermediate mode gives the driver a second chance to recognize this and to return to off-road mode, if necessary.

In another embodiment of the invention, the different modes may comprise one or more parameter-adapted modes associated with the operation rules, by which the selected mode is adapted to different parameters such as load, speed and the like. As an example, rule a may include automatic selection among two or more load-adapted sport modes, each associated with a preset load-range, such that the characteristics of the sport mode automatically is adapted to the actual load in the vehicle.

In alternative embodiments other subsystems, sensors, accessory systems may be comprised in the vehicle control system 10 of the invention. In a basic embodiment of the vehicle control system 10, it is capable of controlling a number of controllable motor vehicle subsystems 30-80 according to at least two preset vehicle operating modes, it comprises at least one sensor 100-130 for registering current operating conditions, and the central control unit 20 is arranged to limit access to at least one of the preset operating modes in response to an output value from at least one such sensor 100-130.

Driver Interface:

To further prevent use of the vehicle in a non-suitable operating mode, to simplify usage of the vehicle in the active operating mode, and to keep a high level of security, it is of great importance that the driver of the vehicle is informed and made aware of the active mode in an intuitive and clear manner. To meet these requirements, the output arrangement 94 of the driver interface 90 preferably is fully integrated with the dashboard of the vehicle.

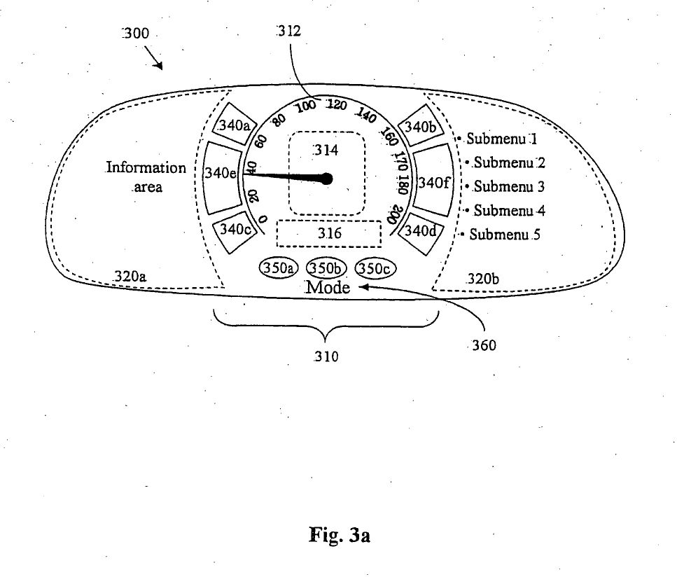

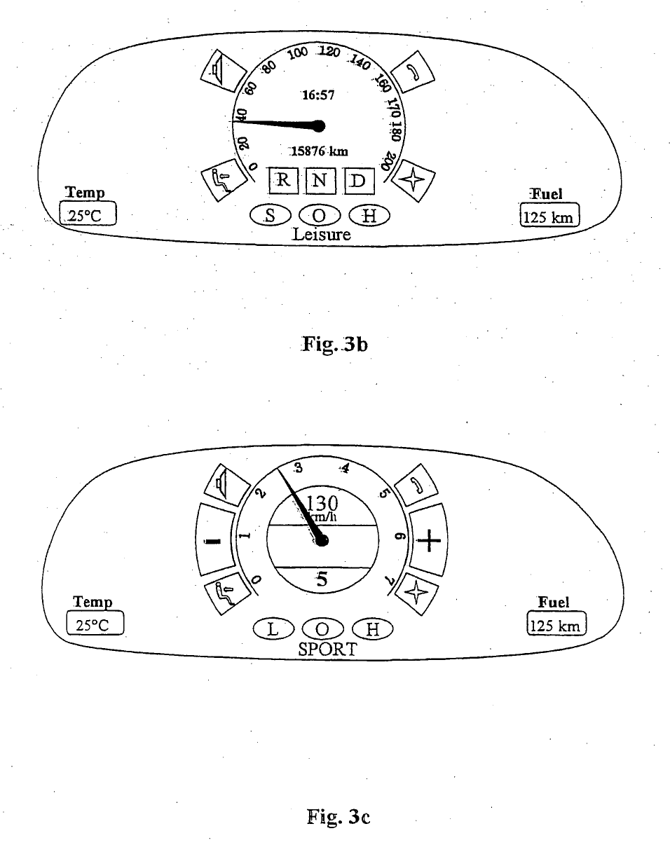

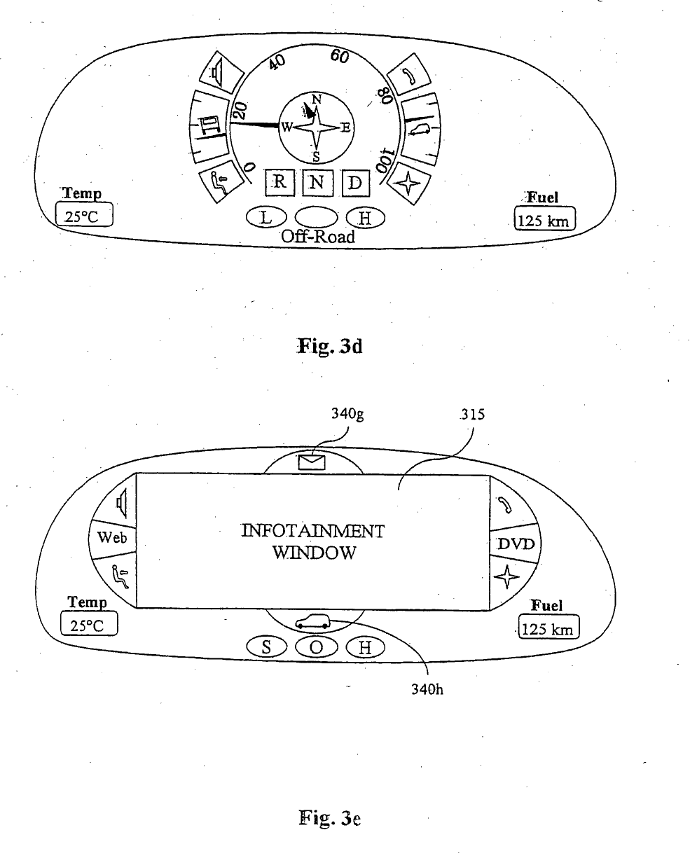

In a preferred embodiment of the invention the dashboard is formed by a graphical-display, such as a LCD, EL, CRT or Plasma-display, on which the normal meters and gauges, such as speedometer, revolution counter, and fuel gauge, are shown as graphical elements in mode-adapted dashboard-images that are easy to distinguish from each other. FIGS. 3b to 3e shows schematic examples of four mode-adapted dashboard-images 300, whereas the image shown in FIG. 3a is a schematic view used for illustrative purposes, 3b is adapted for Leisure mode, FIG. 3c for Sport-mode, FIG. 3d for Off-road mode, and FIG. 3e for Parking mode.

To facilitate dashboard intelligibility when switching modes, a unitary structure is preserved throughout the different mode adapted dashboard-images 300, as can be seen in FIGS. 3a to 3e. As is shown in FIG. 3a, the dashboard-image 300 is similar in design to a conventional dashboard, and it is basically comprised of a centrally arranged main section 310 for displaying vital driving related information, and two submenu/information areas 320a, 320b adjacent to the main section 310. More specifically the main section 310 comprises a large substantially circular analogue meter 312 for displaying the speed (or rpm in sport mode), a gear field 314 for displaying selected gear, and a misc. info field 316 for displaying other information and important alerts. The main section 310 further comprises six selection fields 340a-f disposed along the perimeter, three shortcut fields 350a-c at the lower section, and a text field 360 for displaying the active mode in text format. The selection fields 340 form a part of a menu system used for controlling the features of the vehicle control system 10, and the location relative the center of the main section 310 indicates how the selection field 340 is selected with the input arrangement 92 of the driver interface 90. The mode-adapted dashboard images are further adapted to simplify usage of the vehicle in the active operating mode in that they show mode-specific meters and available choices.

FIG. 3b shows an example of a leisure mode dashboard-image 300. Herein the analogue meter 312 is used for displaying the speed, the gear field 314 displays the selected gear by highlighting the appropriate symbol, and the misc. info field 316 is used for displaying the time, the mileage and, when necessary, important alerts. The four selection fields 340a-d are used to access the submenus of the audio entertainment, mobile phone, climate control, and navigation systems, respectively. In the top menu state, the function associated with the shortcut fields 350a-c is direct selection of the alternative operating modes, sport, off-road, and heavy load, respectively, but when any of the selection fields 340a-d is selected their functions alter, which will be described in detail below. Furthermore, in the top menu state, the submenu/information areas 320a, 320b are only used for displaying outdoor temperature and fuel level, respectively, but the large unused areas are used for displaying submenus when any of the selection fields 340a-d is selected.

FIG. 3c shows an example of a sport mode dashboard-image 300. Unlike in leisure mode, the analogue meter 312 is used for displaying the rpm, the gear field 314 displays the manually selected gear as a figure, and the misc. info field 316 is used for displaying the speed in figures and, when necessary, important alerts. Furthermore, the selection fields 340e and f display how manual gear shifting is performed, and in this mode they refers to gear-shifting buttons on the steering wheel. The function associated with the shortcut fields 350a-c is direct selection of the alternative operating modes, leisure, off-road, and heavy load, respectively.

FIG. 3d shows an example of an off-road mode dashboard-image 300. Like in leisure mode, the analogue meter 312 is used for displaying the speed, but with a reduced speed interval as the mode is restricted for use under a predefined speed limit. The gear field 314 displays the selected gear by highlighting the appropriate symbol, and the misc. info field 316 is used for displaying a compass and, when necessary, important alerts. As above, the function associated with the shortcut fields 350a and c is direct selection of the alternative operating modes, leisure, and heavy load, respectively, but the shortcut field 350 b is not used, as operation rule h does not permit direct selection of sport mode from off-road mode. Furthermore, the areas normally occupied by the selection fields 340e and f are used for displaying tilting meters.

FIG. 3e shows an example of a parking mode dashboard-image 300. To utilize a larger section of the dashboard-display for infotainment purposes or the like, the main section 310, now in the form of an infotainment window 315, is expanded at the sacrifice of the submenu/information areas 320a, 320b, and the submenus are now displayed direct in the infotainment window 315. As will be discussed below, a large number of infotainment features are available to the driver in parking mode and selection fields 340e and f plus additional selection field 340g are used to provide access to these features. Additional selection field 340 is used to access different non-mode specific features and accessories, such as the electrically foldable towing hook and the like.

In alternative embodiments of the driving mode dashboard-images 300, it is possible to access to the non-mode specific features and accessories, but the features or accessories that may be selected in the different modes are restricted by the operating rules a-f.

To further distinguish the different mode adapted dashboard-images 300, they are preferably designed using different color-schemes and background patterns. In one embodiment the leisure mode dashboard-image 300 has a black background and yellowish-red instruments like a conventional dashboard, the sport mode dashboard-image 300 has a blue background, and the off-road mode dashboard-image 300 has a green background, e.g.

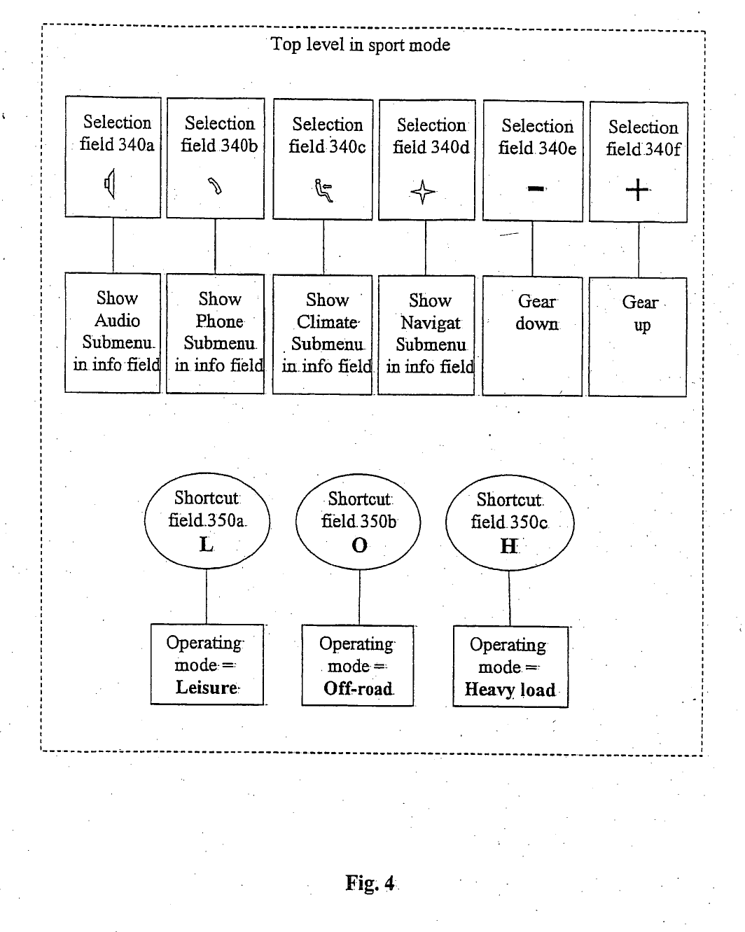

FIG. 4 schematically shows the menu options for the selection fields 340a-f and the shortcut fields 350a-c in top menu state of the sport mode. The four selection fields 340a-d are used to access the submenus of the audio entertainment, mobile phone, climate control, and navigation systems, respectively. If one of the selection fields 340a-d is selected, the associated submenu appears in the information field, and further selections can be made in the submenu.

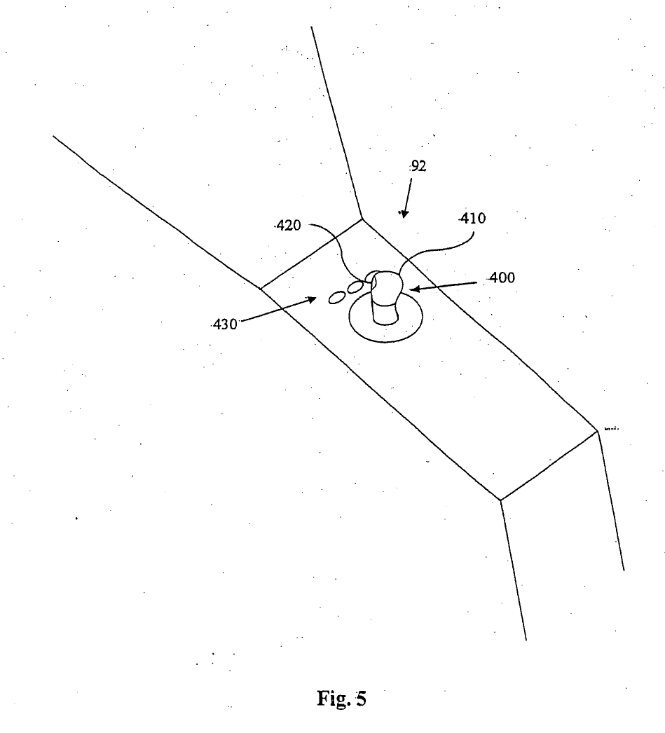

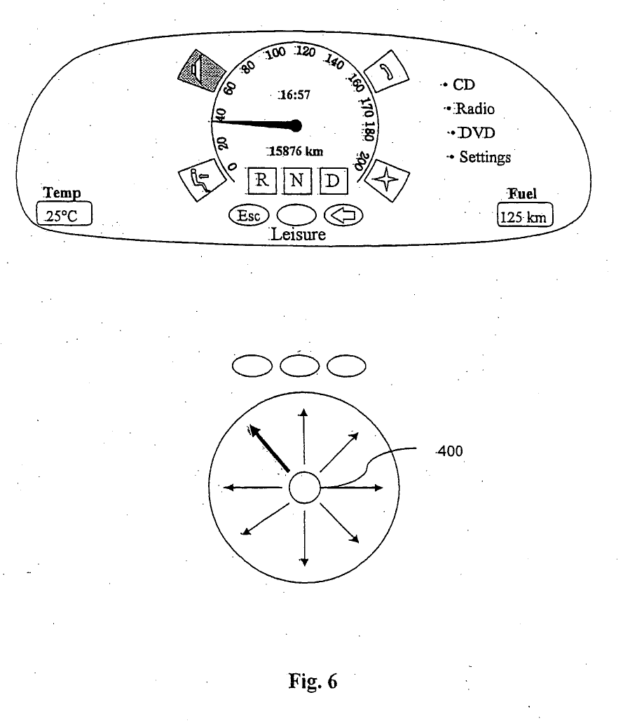

As mentioned above, the input arrangement 92 can be of several different types. In one preferred embodiment, shown in FIG. 5, the input arrangement 92 is suitable to arrange in the center console and comprises an actuator of joystick type 400, a rotary selector 410 and a push button 420 both arranged on the actuator 400, and three shortcut keys 430 arranged in front of the actuator 400. To facilitate selection of selection fields under rough driving conditions, the actuator 400 is preferably guided to a number of perimeter positions corresponding to the selection fields of the main section. The input arrangement 92 may further comprise a number of steering wheel shortcut keys arranged on the steering wheel for direct access to important features.

FIG. 6 shows how a selection field is selected using the actuator 400, whereby a submenu appears in the information field 320b. The selection in the submenu is performed by the rotary selector 410 and the push button 420.

In one special embodiment, force-feedback controlled menu selection is utilized, whereby the actuator 400, by force-feedback, is prevented from movements in directions that not corresponds to an available selection field 340a-f In this way, the number of selection fields 340a-f may vary between different operating modes and menu levels, and guided selection can be obtained for any number of selection fields 340a-f along the perimeter of the main section 310.

Virtual Codriver:

To further increase safe use of the vehicle, the control-unit 20 is programmed to limit the information that the driver may access depending on the driving situation. To achieve this, a number of access-limiting rules have been formulated, according to which the control-unit decides what information and features that are to be accessible in a specific situation. Examples of such access-limiting rules are shown in table 1.

TABLE 1

| | Basic | | | | |
|---|---|---|---|---|---|
| | driving | Menu | Mobile | | |
| | functions | system | phone | E-mail | Infotainment |
| Parking mode | Yes | Yes | Yes | Yes | Yes |
| 1-60 km/h | Yes | No | Yes | No | No |
| Urban area | | | | | |
| 61-120 km/h | Yes | Yes | Yes | No | No |
| small road | | | | | |
| 61-120 km/h | Yes | Yes | Yes | Yes | No |
| freeway | | | | | |
| 121 - | Yes | No | No | No | No |

In the table the different safety levels mainly depend on the speed and type of driving, but other important factors that may be introduced in the rules are weather conditions, visibility, restricted areas (close to schools etc, road sections with frequent accidents), traffic situation reports and the like.

Having thus described the invention of the present application in detail and by reference to preferred embodiments thereof, it will be apparent that modifications and variations are possible without departing from the scope of the invention defined in the appended claims.

1. Vehicle control system (10), capable of controlling a number of controllable motor vehicle subsystems (30-80) according to at least two preset vehicle operating modes, the control system comprises a central control unit (20) for controlling the motor vehicle subsystems (30-80), and a driver interface (90) with an input arrangement (92) and an output arrangement (94) for selecting operating mode, characterized in that it comprises at least one sensor (100-130) for registering current operating conditions, and that the central control unit (20) is arranged to limit access to at least one of the preset operating modes in response to an output value from at least one sensor (100-130).

2. Vehicle control system (10) according to claim 1, characterized in that it comprises at least one load sensor (100) for registering the load in the vehicle.

3. Vehicle control system (10) according to claim 1, characterized in that it comprises at least one towing sensor (110) arranged to recognize if the vehicle is used for towing a trailer.

4. Vehicle control system (10) according to claim 1, characterized in that it comprises at least one speed sensor (120) arranged to give a signal corresponding to the speed of the vehicle.

5. Vehicle control system (10) according to claim 1, characterized in that it comprises at least one tilting sensor (120) arranged to register tilting of the vehicle.

6. Vehicle control system (10) according to claim 1, characterized in that it comprises at least one controllable accessory system (140-180) and that the central control unit (20) is arranged to limit access to at least one of the preset operating modes in response to a mode of operation of at least one accessory system (140-180).

7. Vehicle control system (10) according to claim 6, characterized in that it comprises a controllable accessory system in the form of a foldable towing hook (140).

8. Vehicle control system (10) according to claim 6, characterized in that the controllable accessory system is in the form of a foldable roof rack (150).

9. Vehicle control system (10) according to claim 1, wherein one of the preset vehicle operating modes is a sport mode, characterized in that the sport mode is not selectable when the load registered by the load sensors (100) exceeds a preset load limit, nor when the towing sensor 110 indicates that there is a trailer hooked onto the towing hook.

10. Vehicle control system (10) according to claim 1, wherein one of the preset vehicle operating modes is a heavy-load mode, characterized in that the heavy-load mode is automatically selected when the load registered by the load sensors 100 exceeds a preset load limit, and when the towing sensor 110 indicates that there is a trailer hooked onto the towing hook.

11. Vehicle control system (10) according to claim 1, wherein one of the preset vehicle operating modes is an off-road mode, characterized in that the vehicle control system 10, in off-road mode, prevents further acceleration when the speed registered by the speed sensor 120 reaches a predefined speed limit, and that off-road mode is locked when the tilting angle registered by the tilting sensor 130 exceeds a predetermined value.

12. Vehicle control system (10) according to claim 1, characterized in that the output arrangement (94) is integrated with a dashboard of display type, and in that the dashboard-image is mode-adapted for each preset operating mode.

13. Automobile, characterized in that it comprises a vehicle control system (10) according to claim 1.

14. Driver interface (90) for controlling a vehicle control system (10), capable of controlling a number of controllable motor vehicle subsystems according to at least two preset vehicle operating modes, characterized in that it comprises a dashboard of display type arranged to display a dashboard-image, and in that the dashboard-image is mode-adapted for each preset operating mode.

15. Driver interface (90) according to claim 14, characterized in that each mode-adapted dashboard-image comprises centrally arranged main section (310) for displaying vital driving related information, and two submenu/information areas (320a, 320b) adjacent to the main section (310).

16. Driver interface (90) according to claim 15, characterized in that the main section (310) comprises a substantially circular analogue meter (312) for displaying the speed or RPM, a gear field (314) for displaying selected gear, a misc. info field (316) for displaying other information and important alerts, a number of selection fields (340 a-h) disposed along the perimeter of the main section (310), and three shortcut fields (350a-c) at the lower section.

17. Driver interface (90) according to claim 16, characterized in that the selection fields (340a-h) form a part of a menu system used for controlling the features of the vehicle control system (10), and the location relative the center of the main section (310) indicates how each selection field (340a-h) is selected with an input arrangement (92) of the driver interface 90.

18. Driver interface (90) according to claim 17, characterized in that the input arrangement (92) comprises an actuator of joystick type (400), a rotary selector (410) and a push button (420) both arranged on the actuator (400), and three shortcut keys (430) arranged in front of the actuator (400).

19. Driver interface (90) according to claim 18, characterized in that the actuator of joystick type (400) is guided to a number of perimeter positions corresponding to the selection fields of the main section.

20. Driver interface (90) according to claim 19, characterized in that the actuator of joystick type (400) is guided by a force-feedback arrangement.

21. Method of operating a vehicle control system (10), capable of controlling a number of controllable motor vehicle subsystems according to at least two preset vehicle operating modes, the control system (10) comprises a central control unit (20) for controlling the motor vehicle subsystems, and a driver interface (90) for selecting operating mode, characterized by the step of, limiting possible mode selections in accordance with a number of preset operation rules.

22. Method according to claim 21, characterized by the step of registering current operating condition using at least one sensor (100-130), and in that at least one operation rule limit access to at least one of the preset operating modes in response to an output value from at least one sensor (100-130).
